(19) United States
(12) Patent Application Publication
(10) Pub. No.: US 2015/0112841 A1
(43) Pub. Date: Apr. 23, 2015

(54) METHOD AND SYSTEM FOR IDENTIFYING MATCHING GOODS AND SERVICES

(71) Applicant: SpotHopper LLC, Shorewood, WI (US)

(72) Inventors: Aleksandar Ivanovic, Milwaukee, WI (US); Stefan Ivanovic, Shorewood, WI (US); Nikola Ivanovic, New York, NY (US)

(73) Assignee: SpotHopper LLC

(21) Appl. No.: 14/518,675

(22) Filed: Oct. 20, 2014

Related U.S. Application Data
(60) Provisional application No. 61/893,535, filed on Oct. 21, 2013.

(51) Int. Cl. G06Q 30/06

(52) U.S. Cl. CPC G06Q 30/0627; G06Q 30/0641
USPC 705/26.63

(57) ABSTRACT

A method and system for matching a consumer to a desired product is disclosed. Each of the products is initially described using a defined list of characteristics. Each of the characteristics is defined on a scale, and the consumer provides a value on the scale when describing the desired product. The consumer creates a search by entering values for the characteristics describing the product that are important to that consumer. Each of the entered values in the search is compared against the list defining a particular product. The matching routine ranks each of the products that most closely match the search by the consumer. The search results are further filtered according to the present location of the consumer. The filtered results are presented to the consumer to provide a list of products that best match the desired product and that are located proximate to the consumer.

### CROSS-REFERENCE TO A RELATED APPLICATION

This application claims the benefit of the filing date of U.S. Provisional Patent Application Ser. No. 61/893,535, filed Oct. 21, 2013 and entitled “Method of Identifying Matching Goods and Services,” the subject matter of which is hereby incorporated by reference in its entirety.

### BACKGROUND OF THE INVENTION

1. Field of the Invention

The subject matter disclosed herein relates to a computerized method and system for locating goods and services for which a consumer is searching. More specifically, objective criteria describing multiple characteristics of goods and services are utilized to provide more accurate matching of goods and services to the good or service which a consumer desires.

2. Discussion of the Related Art

As is known to those skilled in the art, the Internet provides an abundance of information readily accessible to consumers. However, the sheer volume of data sometimes makes it difficult for a consumer to locate a specific good or service. Alternately, the information that is available may not be presented in a manner suitable for searching. For example, a consumer may be in an unfamiliar geographic region and desire to locate a restaurant for dinner. Although the consumer may search for restaurants located within the region, the search results typically overwhelm with the number and type of restaurants.

Even though a large number of restaurants may be returned as a result of the search, the consumer may still be unable to identify a restaurant that matches the desired place to dine. Some websites may provide lists, such as a “best of” or “top ten” list of restaurants that may not be searchable by additional criteria. Some websites permit further searching, for example, by cost and/or type of cuisine. However, such searching has drawbacks. The additional searching typically is limited in scope and does not provide adequate search criteria for the consumer to be certain that a restaurant located by the website matches the type of restaurant at which the consumer wishes to dine. The consumer may have a favorite restaurant against which he or she is comparing the search results. If the restaurant happens to be a national chain and there is a local franchise, the consumer may be confident that he or she will enjoy the meal. If, however, the favorite restaurant is locally owned and the consumer wishes to find a similar restaurant in the new region, it is not possible to compare the local search results to a favorite restaurant. The resultant uncertainty may lead to substantial consumer disappointment.

It is also known that many websites offer reviews of goods and services. However, such reviews are also not without certain drawbacks. The reviews are based on subjective opinions of users, which may be skewed by an uncharacteristic experience. Further, reviews often are posted by people having very strong opinions either for or against the good or service, and may not reflect a majority opinion of the good or service. Thus, while reviews may provide additional information to the consumer, they may be at least somewhat misinformative.

Consequently, it would be desirable to provide an improved computerized method and system to match a consumer to a desired good or service.

### SUMMARY OF THE INVENTION

The subject matter disclosed herein describes an improved computerized method and system for matching a consumer to a desired good or service. Each of the goods or services is initially described using a defined list of characteristics. The list of characteristics may be customized for each type of good or service and includes features that describe the good or service in detail. The lists of characteristics are stored in a database on a central server. Each of the characteristics is defined on a scale, such that the consumer may provide a value within the range of the scale when describing the desired good or service. To initiate a search, a consumer launches an application on his or her mobile device. The consumer enters values for the characteristics describing the good or service that is important to that consumer on the mobile device. Each of the entered values in the search is transmitted to the central server and compared against each of the lists defining particular products that are stored on the server. The server executes a matching routine that ranks each of the goods or services that most closely match the values of the characteristics entered by the consumer. After ranking the goods and services, the results are further filtered according to the present location of the consumer, where the central server obtains the consumer's location from the mobile device either along with the transmission of the characteristic values entered by the consumer or on a periodic interval while the mobile device is executing the application. The central server transmits the filtered results back to the consumer's mobile device. The filtered results are presented to the consumer on a display of the mobile device to provide a list of goods or services that best match the desired good or service and that are located proximate to the consumer.

According to one embodiment of the invention, a method of identifying one of a desired good and a desired service is disclosed. The method includes the steps of receiving a list of characteristics corresponding to the desired good or service with the mobile device, where the list of characteristics includes a range of values for each characteristic. The list of characteristics corresponding to the desired good or service may be transmitted to the mobile device from a server in communication with the mobile device via a network. Optionally, the list of characteristics may be retrieved from memory in the mobile device. A value is entered for at least one characteristic for the desired good or service using a user interface on the mobile device. Each value is selected from within the range of values for the at least one characteristic. The values for each characteristic entered from the mobile device are transmitted to the server in communication with the mobile device via the network. The mobile device includes a positioning module that generates location data, and the location data is transmitted to the server via the network. The mobile device receives a results list of goods or services from the server via the network. The server generates the results list by comparing the values for each characteristic to a corresponding value in a plurality of lists of characteristics stored in a storage device in communication with the server. Each list of characteristics corresponds to a one of the goods or services, and each of the lists may include a predefined rating within the range of values for each of the characteristics in the list. The predefined rating may include an objective component and a subjective component, where the objective component may be greater than the subjective component. The results list is generated by ranking each of the plurality of goods or services stored in the storage device of the server according to the comparison between the values for each characteristic and the predefined rating for the corresponding characteristic and by filtering each of the ranked plurality of goods or services according to the location data. The results list is displayed on a display of the mobile device.

According to another aspect of the invention, the objective component of the predefined rating may be assigned by a provider of the good or service. Optionally, the objective component may be assigned by an independent third party. According to still another option, the objective component may be a weighted average of values assigned by the provider and by the independent third party. Each of the objective components corresponds to and is within the range of values for one of the characteristics in the list for the good or service. The subjective component of the predefined rating is assigned by one or more users. Each user assigns a value for the characteristic and the subjective component is an average of the values assigned by all of the participating users.

According to still another aspect of the invention, the step of retrieving the present location of the mobile device is repeated at a periodic set or variable interval. The ranked plurality of goods and services are filtered at the periodic interval to generate a new results list, and the new results list is transmitted to the mobile device.

According to yet another aspect of the invention, a provider of each of the plurality of goods or services in the results list transmitted to the mobile device is identified. The user checks in to one of the providers with the mobile device and obtains a second results list on the mobile device that identifies the goods or services offered by the identified provider.

According to another embodiment of the invention, a method of matching at least one user of a good or a service with at least one provider of the good or the service is disclosed. The method includes the steps of storing a plurality of lists of characteristics in a storage device in communication with a server. Each of the lists includes an assigned value for each characteristic defining the good or service from the at least one provider. The assigned value may include an objective component and a subjective component, and the objective component may be greater than the subjective component. Either a user or a provider enters a description of the good or service via a user interface on a remote processing device. The description of the good or service is transmitted from the remote processing device to the server via a network in communication with the remote processing device and the server. Location data is generated in a positioning module on a user's remote processing device and transmitted to the server via the network. When the user selects the desired good or service, at least one provider of the good or service is identified. When the provider selects the desired good or service, at least one user of the good or service is identified. The provider or the user is identified as a function of the values assigned for each characteristic of the desired good or service and further identified as a function of a location data from the user.

According to another aspect of the invention, the provider selected the desired good or service and enters a promotion on the remote processing device via the user interface, where the promotion is related to the desired good. The provider also enters a notification criterion via the user interface on the remote processing device. The promotion and the notification criterion are both transmitted from the remote processing device to the server via the network. The user of the good or service may be further identified as a function of the notification criterion, and the server transmits the promotion to the mobile device of each of the users identified. The notification criterion may be a desired number of users and the server may identify each of the desired number of users which are closest to the provider as a function of the location data from the user.

According to still another aspect of the invention, each of the users responding to the promotion may be stored in the storage device of the server. The number of users responding to the promotion may be monitored for a predefined time. If the number of users responding to the promotion is less than the desired number of users after the predefined time, an additional number of users, corresponding to the difference between the desired number of users and the number of users responding to the promotion of the good or service, may be identified. The additional users are the next closest users to the provider that satisfy the notification criterion.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a block diagram representation of a system and method of identifying matching goods or services according to one embodiment of the invention;

FIG. 2 is a block diagram representation of a mobile device, a provider, and a server configured to implement the method of identifying matching goods or services according to one embodiment of the invention;

FIG. 3 is an exemplary screen shot illustrating a login screen of a matching application executing the method of identifying matching goods or services according to one embodiment of the invention;

FIG. 4 is an exemplary screen shot illustrating a home screen of a matching application executing the method of identifying matching goods or services according to one embodiment of the invention;

FIG. 5 is an exemplary screen shot illustrating a product selection screen of a matching application executing the method of identifying matching goods or services according to one embodiment of the invention;

FIG. 6 is an exemplary screen shot illustrating a create new product screen of a matching application executing the method of identifying matching goods or services according to one embodiment of the invention;

FIG. 7 is an exemplary screen shot illustrating a favorite product screen of a matching application executing the method of identifying matching goods or services according to one embodiment of the invention;

FIG. 8 is an exemplary screen shot illustrating an adjust sliders screen of a matching application executing the method of identifying matching goods or services according to one embodiment of the invention;

FIG. 9 is an exemplary screen shot illustrating a product match screen of a matching application executing the method of identifying matching goods or services according to one embodiment of the invention;

FIG. 10 is an exemplary screen shot illustrating a product inventory screen of a matching application executing the method of identifying matching goods or services according to one embodiment of the invention;

FIG. 11 is an exemplary screen shot illustrating a promotion screen of a matching application executing the method of identifying matching goods or services according to one embodiment of the invention; and

FIG. 12 is an exemplary screen shot illustrating a desired draw screen of a matching application executing the method of identifying matching goods or services according to one embodiment of the invention.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

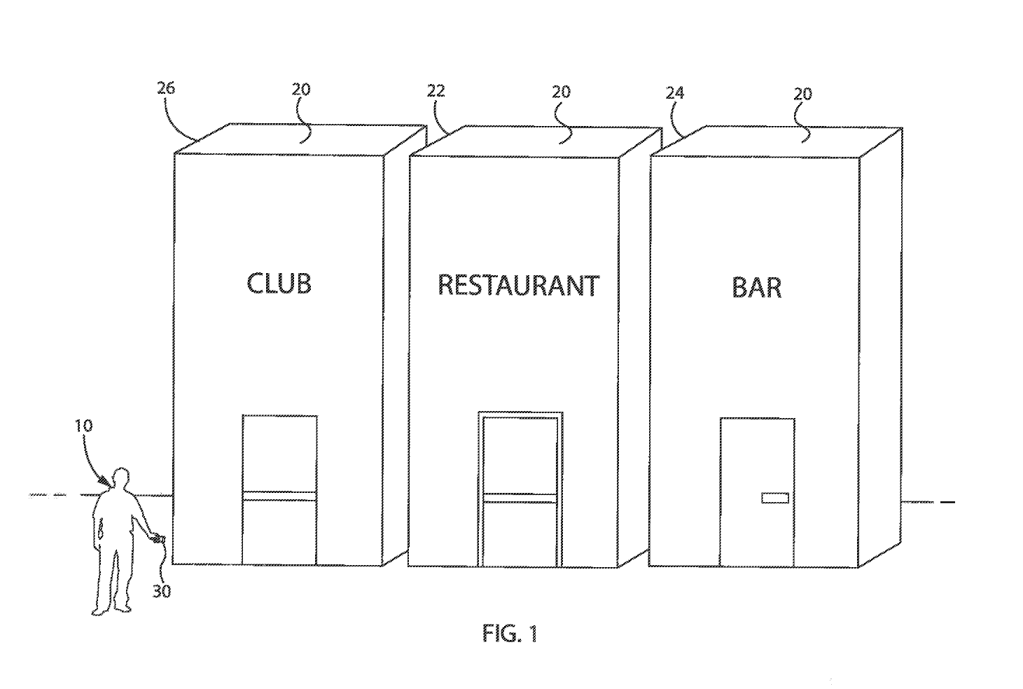

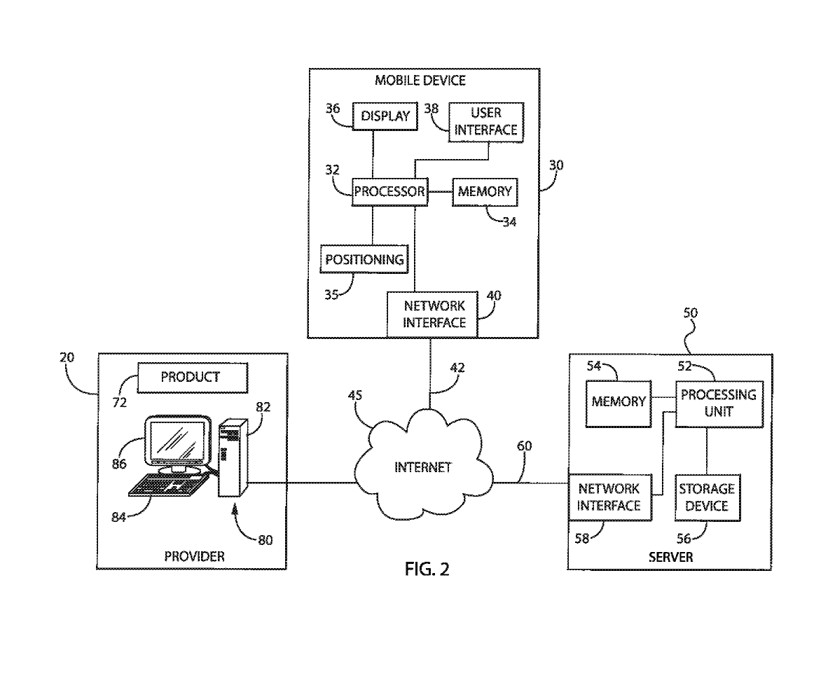

Turning initially to FIG. 1, a user 10 is interested in locating a provider 20 offering a desired product or service. According to the exemplary embodiment, the user 10 wishes to find someplace to dine. The user 10 may wish to have a sit-down dinner, which may be best provided by a restaurant 22, or, alternately, prefer appetizers and a drink, which may be best provided by a bar 24. According to yet another option, the user 10 may wish to have entertainment or dancing in addition to a drink, which may be best provided by a club 26. The user 10 uses a mobile device 30, such as a cellular phone, which is in communication with the Internet 45, see also FIG. 2, to search for the provider 20 that best matches the desired product or service.

Referring next to FIG. 2, the mobile device 30 includes a processor 32 in communication with a memory 34. The processor 32 may be a single processor or multiple processors executing independently or in parallel. The memory 34 may be a single device or multiple devices and may be volatile or non-volatile memory. The memory 34 stores a plurality of instructions configured to be executed on the processor 32. A positioning module 35 is configured to provide the present location of the mobile device 30. The positioning module 35 may be a separate module, integrated with the processor 32 or a combination thereof. According to one embodiment of the invention, the positioning module 35 is in communication with the Global Positioning System (GPS) to obtain the present location of the mobile device 30. The mobile device 30 also includes a display 36 to provide visual data to a user and a user interface 38 to receive input from the user. The user interface may include, but is not limited to, one or more buttons, a touchpad, a touch-screen interface, or a combination thereof. The mobile device 30 further includes a network interface 40 for connection to a network such as the Internet 45 via a network connection 42. According to one embodiment of the invention, the network interface 40 provides communications to a cellular network which, in turn, is connected to the Internet 45. Optionally, the mobile device 30 may include a local wireless interface, such as Wi-Fi or Bluetooth, which connects to a wireless router and then to the Internet 45. According to yet another embodiment, the network interface 40 includes a port, such as a USB port (not shown), through which a wired network connection may be established to the Internet 45. If the network interface 40 establishes a wireless connection, a suitable antenna is integrated in the wireless device 30. Of course, a single device may be configured with two or more of these connections.

The server 50 may include a single processing unit 52 or, optionally, include multiple processing units 52 at a single location or distributed across multiple locations each linked by an appropriate network, such as the Internet 45 or an intranet. Each processing unit 52 may include a single processor or multiple processors executing independently or in parallel and is in communication with a memory 54. The memory 54 may be a single device or multiple devices and may be volatile or non-volatile memory. The memory 54 stores a plurality of instructions, or applications, configured to be executed on the processing unit 52. The processing unit 52 is also connected to one or more storage devices 56 to store data. The storage devices 56 may be of any type known in the art, including but not limited to, hard drives, compact discs (CDs), digital video discs (DVDs), non-volatile flash memory, magnetic tapes, or any other suitable storage media. The applications may be executed by one or multiple processors of the processing units. The data may be stored in databases on a single storage device 56 or across multiple storage devices 56 connected to the servers. The server 50 may include a first database used to store lists of characteristics for each type of product, a second database to store user account information, and a third database to store saved searches. Optionally, the application modules and databases may be structured according to any suitable division or combination of features and/or data as known to one skilled in the art.

Each provider 20 includes a computer 80 configured to communicate with the server 50 via the Internet 45. According to the illustrated embodiment, the computer 80 includes a processing unit 82, a monitor 86, and a user interface 84, such as a keyboard. Optionally, various other types of computers 80 such as notebook, laptop, and tablet computers may be utilized. Further, the computer may include various other devices, interfaces, and peripheral equipment connected to the computer 80 according to the requirements of the provider 20. It is further contemplated that the computer 80 at the provider 20 may be configured to communicate directly with a mobile device 30, for example, via a wireless connection such as Wi-Fi. Optionally, the computer 80 may communicate to a mobile device 30 indirectly via the Internet 45 and/or the server 50. Each provider 20 provides at least one product 72, which may be a good or a service, to a user 10.

In operation, the method of identifying a desired good or service as disclosed herein allows users to specify with detail the types of goods or services that they are looking for by defining each good or service using a set list of characteristics. Each characteristic is further categorized or grouped according to a range of values, for example, from 0 to 10. Different types of goods or services have a different list of characteristics, and each good or service has a different set of values for each characteristic defining that good or service.

The server 50 includes a database stored on a storage device 56 which contains the different lists of characteristics for each good or service. A new good or service is added to the list by defining initial values for each of the characteristics in the list corresponding to that good or service. According to one embodiment of the invention, each value includes an objective component and a subjective component. The objective component may have a greater weight than the subjective component when setting each initial value. By providing a greater weight to the objective component a user is more likely to receive a results list that identifies goods or services that match the user's expectations. The objective component may be set, for example, by an expert on each good or service. The expert selects the value that best represents the good or service within the range of values assigned for each characteristic. The objective component may further include values set by the provider of the good or service. In a similar manner to the expert, the provider also selects the value that best represent the good or service within the range of values assigned for each characteristic. The objective component may be set to the value selected by the expert, the value selected by the provider, or an average of the two values weighted either evenly or favoring one of the two values. The subjective component may initially be undefined, or optionally, one or more users of the good or service may provide a value that they feel best represents the good or service for each characteristic. As additional users 10 review each good or service the value of the subjective component may change as a moving average of each review.

It is further contemplated that each characteristic in the list for a good or service may be assigned an importance factor. If, for example, a product is described by a list of five characteristics, each characteristic may be assigned an importance factor between one and five. The characteristic having an importance factor of one is more important when determining whether a desired product is a match than the characteristic having an importance factor of five.

According to another exemplary embodiment, a kitchen or dining room table may be described by a list of characteristics including: the number of people that may sit at the table, the height of the table, the style of the table, the color of the table, and the level of distressing on the table. The number of people may be assigned an importance factor of one and the level of distressing may be assigned an importance factor of five. Thus, when a user 10 searches for a table having certain characteristics, the matching application 100 will place a higher emphasis on matching tables that seat the correct number of people than on the desired level of distressing for the table. It is contemplated that these importance values will be assigned when the list of characteristics is initially established for a product. Similar to the values for each characteristic, the importance value may be selected by the expert, the provider, or an average of the two values weighted either evenly or favoring one of the two importance factors.

When each product is initially entered into a database on the storage device 56, either by the expert or by the provider, one or more locations at which the product may be obtained may similarly be stored. For example, referring again to FIG. 1, a first bar 24 may indicate it sells Brand A beer. The values of defined characteristics for Brand A beer may have been initially defined by an expert and stored in a database in the storage device 56. The expert-generated data may or may not have included a location at which Brand A beer may be purchased. Each provider 20 may have a version of the matching application 100 or a separate application with features not available to a user 30. In addition to conducting searches for matching products, the provider's application permits the provider 20 to identify itself as a provider of a particular product. The bar 24 may, for example, conduct a search for Brand A beer. If Brand A beer is stored in the storage device 56, the provider 20 then indicates that it carries Brand A beer. Alternately, Brand A beer and a corresponding list of its characteristics may not yet have been stored in the storage device 56. When the bar 24 conducts the search for Brand A beer, the results list does not include Brand A beer. An owner, bartender, or other person with knowledge of the product from the bar 24 may then enter a set of values for the characteristics of Brand A beer via the user interface 84 on the bar's 24 computer 80 and transmit the set of values to the storage device 56 as a new product. The bar 24 additionally includes itself as a provider 20 of Brand A beer. Other providers 20 (e.g., bars 24, restaurants 22, and clubs 26) which also offer Brand A beer may similarly identify themselves as providers 20 of Brand A beer via their respective computer 80 and store their location in the database on the storage device 56 as additional providers 20 of Brand A beer. The storage device 56 may include a first database storing the values of the characteristics of each product and a second database storing the locations at which the product may be purchased. Optionally, the values of the characteristics and the location may be stored in a single database. According to still another option, multiple databases may be generated corresponding to the type of product. It is contemplated that still other configurations and numbers of databases may be included on the storage device 56 without deviating from the scope of the invention.

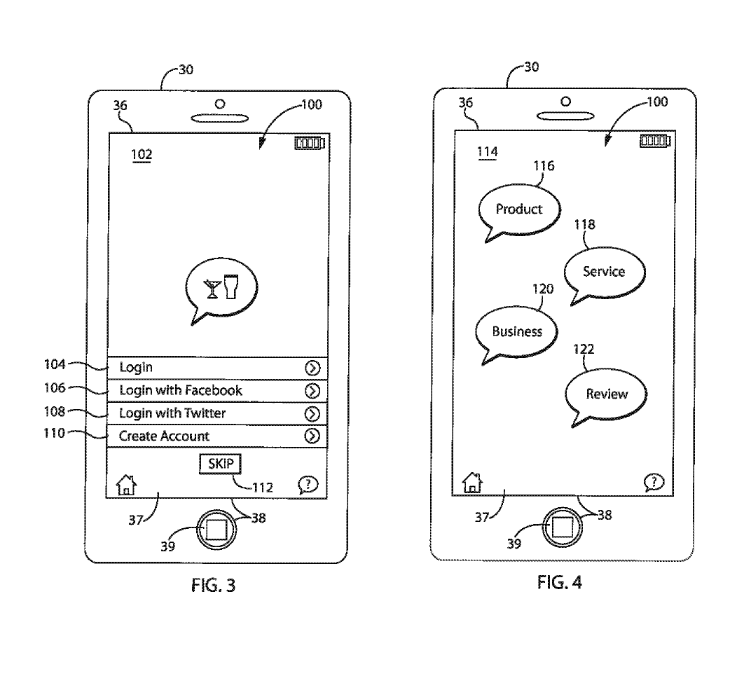

Turning next to FIG. 3, a user 10 launches the matching application 100 via the user interface 38 on the mobile device 30 in order to locate a desired good or service. A login screen 102 is shown on the display 36. The user 10 uses the touch screen 36 to indicate how he or she wants to log in to the matching application 100. The user 10 may choose to login directly, for example, with a login option bar 104. Optionally, the user 10 may choose to login using a social media account such as Facebook® or Twitter® using a corresponding login option bar 106, 108. If the user 10 selects one of the social media login option bars 106, 108, the matching application 100 may be configured to launch a web browser application and take the user 10 to a login screen for the respective social media account. The matching application may either capture the login information as it is entered by the user 10 or retrieve login information stored in the memory 34 of the mobile device 30 if the user 10 has previously stored login information for their social media account. If a user 10 does not have an account and does not wish to use a social media account, the user 10 may create a new account with the create account option bar 110. The user 10 is identified via a user identification or user name and password associated with the account for the matching application 100 or the social media account. According to yet another feature of the matching application 100, the user 10 may select the skip icon 112 on the touch screen 37 and proceed without logging in.

Referring next to FIG. 4, a home screen 114 is then shown to the user 10 on the display 36. At the home screen 114, the user 10 selects the desired product, service, or business for which they are searching. Various icons or buttons are presented from which the user 10 may make a selection (icons are displayed in this embodiment). For example, the user 10 may select a product icon 116, a service icon 118, or a business icon 120. Optionally, the user 10 may press a review icon 122 to provide a user review of a product, service, or business which they have utilized or frequented. Selection of a first icon, for example, the product icon 116 may launch a secondary selection screen, allowing the user 10 to enter a specific product type such as “beer.” Optionally, the secondary selection screen may present the user 10 a menu of products, arranged categorically, alphabetically, a combination thereof, or according to any other suitable arrangement(s). Having identified a specific product, the user 10 may be provided one of several options for entering the desired characteristics of the product.

Turning next to FIG. 5, the user 10 is provided an interface to enter the desired characteristics of the good or service for which he or she is searching. As illustrated in FIG. 5, the user 10 selected the product icon 116 from the home screen 114. A “product selection” screen 130 is shown on the display 36 to the user 10. The product selection screen 130 may be launched directly from the home screen 114 or, optionally, an intermediate screen may be presented to the user 10 to provide for selection of a specific product. The user 10 then selects an option for entering the desired characteristics of the product via the user interface 38 which, as illustrated, may be include a touch screen 37 and at least one selection button 39. The matching application 100 provides several options for the user 10 to identify a desired characteristic. According to the illustrated embodiment, the user 10 may select a “create new product” option bar 132, a “favorite product” option bar 134, or an “adjust sliders” option bar 136.

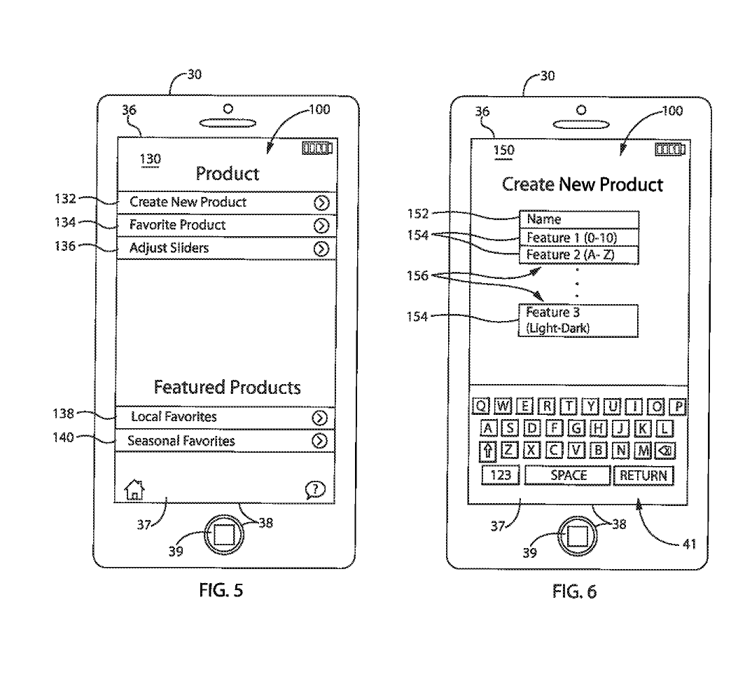

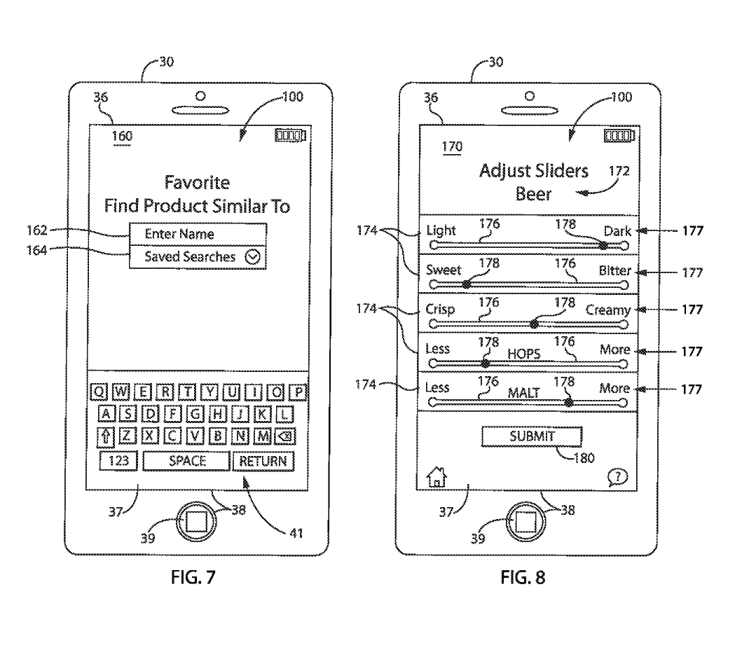

With reference also to FIG. 6, the “create new product” option bar 132 allows the user 10 to manually enter the characteristics of the desired product. A “create new product” screen 150 is shown on the display 36. The “create new product” screen 150 may include text boxes, pull-down menus, icons, a QWERTY keyboard 41, or other prompts for the user 10 to enter information via the touch screen 37. As illustrated, a name text box 152 allows the user 10 to enter a name and/or a description using the QWERTY keyboard 41 to describe the product for which the user 10 is searching. A series of feature windows 154 may be provided to the user 10 to describe characteristics of the product for which the user 10 is searching. The feature windows 154 may be automatically populated from the list of characteristics stored in the storage device 56 of the server 50 corresponding to the specific type of product for which the user 10 is searching. Optionally, the user 10 may select one or more characteristics from the list stored on the storage device 56. The range of values 156 for each characteristic is also displayed, and the user 10 enters a value selected from within the range of values 156 that best describes the product for which the user 10 is searching. As illustrated, the range of values 156 may be numeric, alphanumeric, descriptive, or any other method of suitably describing the characteristic of the product. Once the user 10 has entered a description of and a value for each of the characteristics corresponding to the product, the user 10 may initiate a search for the desired product. Optionally, the user 10 may also save the search for future use. The search may be stored, for example, in the memory 34 on the mobile device 30 or on the storage device 56 of the server 50. The user identification or user name entered by the user 10 when logging in to the matching application 100 may also be stored with the saved search for future reference. With reference also to FIG. 7, the “favorite product” option bar 134 allows the user 10 to retrieve previously stored searches. A “favorite product” screen 160 is shown on the display 36. The “favorite product” screen 160 may include text boxes, pull-down menus, a QWERTY keyboard 41, or other prompts for the user 10 to enter information via the touch screen 37. As illustrated, a name text box 162 allows the user 10 to enter a name and/or a description using the QWERTY keyboard 41 to describe the product for which the user 10 is searching. After the name and/or description is entered, the mobile device 30 retrieves the previously stored search having the same name and/or description. If the search was saved in the memory 34 on the mobile device 30, the matching application 100 may directly retrieve the saved search. If the search was saved on the storage device 56 corresponding to the server 50, the matching application 100 communicates with the server 50 to retrieve the saved search. A description of and the values previously entered for each of the characteristics in the saved search may be presented to the user 10 on the display 36 using, for example, the “create new product” screen 150 or a similar screen in which each of the text boxes and/or pull down menus are populated based on the values from the saved search. The user 10 may then initiate a search for the desired product. Optionally, the matching application 100 may retrieve saved searches either from the memory 34 of the mobile device 30 or from the storage device 56 which include the user identification or user name and generate a saved search list 164 populated from the user's prior searches and present them in a pull-down menu.

With reference also to FIG. 8, the “adjust sliders” option bar 136 allows the user 10 to enter desired product characteristics using a graphical interface. An “adjust sliders” screen 170 is shown on the display 36. As illustrated, the “adjust sliders” screen 170 includes a product description 172, such as beer, for which the user 10 is searching. The matching application 100 on the mobile device 30 communicates to the server 50 to retrieve the list of characteristics from the storage device 56 corresponding to the desired product and their associated ranges of values. The matching application 100 then provides a slider bar object 174 for each of the characteristics in the list. Each slider bar object 174 includes a slider bar 176, a slider 178, and an indicator 177 corresponding to the range of acceptable values for each characteristic. The user 10 uses the touch screen 37 to drag each slider 178 along the slider bar 176 to the point between the minimum and the maximum value of each range corresponding to the desired product for which the user 10 is searching. Once the user 10 has set each slider 178 as desired, the user 10 may initiate a search for the desired product by pressing the submit icon 180. Optionally, the user 10 may also save the search for future use. The search may be stored, for example, in the memory 34 of the mobile device 30 or in the storage device 56 of the server 50. The user identification or user name entered by the user 10 when logging in to the matching application 100 may also be stored with the saved search for future reference.

Referring again to FIG. 5, the matching application 100 may provide still other options to prompt a user 10 to identify a desired product. As illustrated, the matching application 100 may generate one or more lists of suggested products to the user 10. The matching application 100 may read the current location of the mobile device 30 from the positioning module 35 and transmit the coordinates to the server 50. The server 50 may then generate, for example, a list of local favorite products 138 based on user reviews for products in the area. Optionally, the server 50 may retrieve the user's saved searches and customize the list of local products based on prior searches by the user 10. The server 50 may similarly generate a list of seasonal offerings 140 available in the location. It is contemplated that lists of suggested products may be generated based on numerous variables and combinations of the variables including, but not limited to, the location of the mobile device 30, prior searches by the user 10, current specials, and other user reviews. It is also contemplated that various other screens and/or configurations of screens may be presented to the user 10 by the matching application 100 executing on the mobile device 30 to provide the user 10 an interface by which the desired good or service for which the user 10 is searching is entered without deviating from the scope of the invention.

Having obtained a desired product from the user 10, the matching application 100 initiates a search of the database or databases containing corresponding products to identify those products that most closely match the desired product. The user 10 has identified a desired product and entered values (either directly through a textbox or via a graphical interface such as sliders) corresponding to the desired characteristics of the desired product in a mobile device 30. The mobile device 30 transmits the data identifying the product entered by the user 10 to the server 50. The server 50 compares the value entered by the user 10 for each characteristic of the desired product to the corresponding value of each characteristic of each product stored in the storage device 56. Because the list of characteristics for each type of product have been predefined, the characteristics and their associated range of values entered by the user 10 match the list characteristics and their associated range of values stored in the storage device 56. The user 10 may choose to enter values for all or, optionally, for only a portion of the characteristics in the list for the desired product. The matching application will use those characteristics for which the user 10 has entered a value in identifying matching products.

Further, the importance factor is used to provide a weighting to different characteristics in the list. For example, two characteristics of a product may each have a range between one and ten. The first characteristic is assigned an importance factor of one while the second characteristic is assigned an importance factor of five. If the user 10 is searching for a desired product for which the first characteristic has a value of four and the second characteristic has a value of ten, the matching application 100 may assign a higher rank to products stored in the storage device which have values of either three or five (i.e., one step off the desired value) for the first characteristic than products that have a value of ten (i.e., an exact match) for the second characteristic. It is further contemplated that the importance values may similarly be presented to the user 10 on a product selection screen. If a user 10 determines one characteristic is of greater importance to the user 10 than the other, the user 10 may adjust the importance values of each characteristic. The matching application assigns a ranking to each product in the storage device 56 of the same type identified by the user 10 where the highest ranking product most closely matches the product desired by the user 10.

The server 50 additionally filters the ranked products by the current location of the user 10. When the mobile device 30 transmits the set of values entered by the user 10 for the characteristics of the desired product, the mobile device 30 also transmits the current location of the mobile device 30 to the server 50. The matching application 100 obtains the location of the mobile device 30 from the positioning module 35 and includes the location in the data sent to the server 50. The server 50 uses the location of the mobile device 30 to filter the ranked products. According to one embodiment of the invention, the user 10 sets a desired filter as a function of the location of the mobile device 30. For example, the user 10 may select that all products within a 1 mile radius of the mobile device 30 are included in the results. A list of all ranked products within 1 mile is transmitted from the server 50 to the mobile device 30. If no, or too few, results are located or if the user 10 determines that the products identified within the initial radius of the present location of the mobile device 30 do not sufficiently correspond to the desired product, the user 10 may select a broader radius. The server 50 again filters the ranked products to return all products within the new radius. The set of results are transmitted from the server 50 to the mobile device 30. It is further contemplated that the mobile device 30 may periodically transmit its current location the server 50. For example, a user 10 may initiate a search for a desired product during which the initial position of the mobile device 30 is transmitted and an initial set of results is presented to the user 10. The user 10 may be traveling through an area and as the user travels, the mobile device 30 updates the server 50 on its current location. The ranked results may be filtered using the new location and a new set of results transmitted from the server 50 to the mobile device 30.

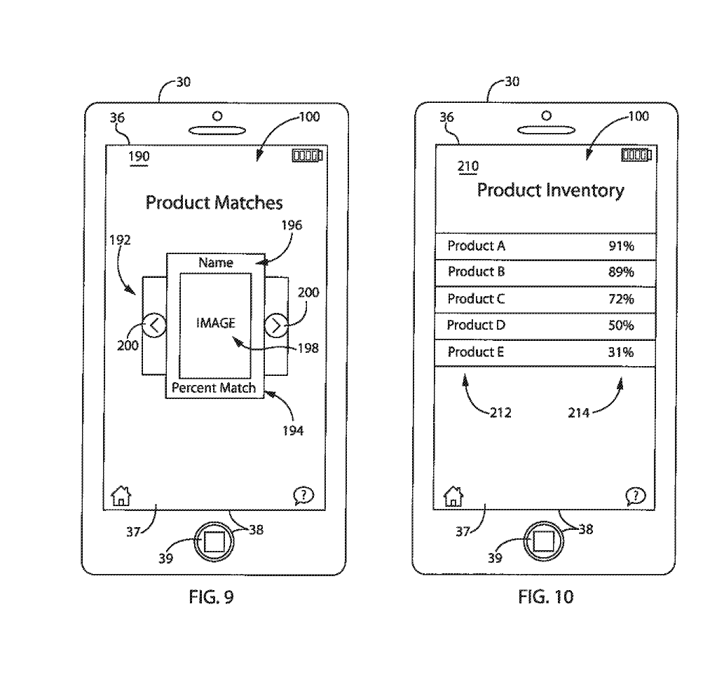

Referring next to FIG. 9, the results are transmitted from the server 50 and presented to the user 10 on the mobile device 30. A “product match” screen 190 is shown on the display 36. The product match screen 190 presents a list 192 of the products on the display 36 according to the rank 194 of each product. The highest ranked product within the set range of the mobile device 30 is listed first. Each additional product that is within the set range of the mobile device 30 is listed in order in descending order of rank. According to one embodiment of the invention, for each product, a name 196 and an image 198 corresponding to the provider 20 of the product is displayed. For example, if the user 10 searches for Brand A beer, a bar 24 that sells Brand A beer may return a 100% match. Similarly, if multiple bars 24 each sell Brand A beer, each bar 24 may be identified as a 100% match. The multiple bars 24 selling Brand A beer may be listed, for example, in order according to their proximity to the mobile device 30. The image 198 may be an exterior image of the provider 20 which may help the user 10 locate the provider or an interior image of the provider 20 which, in the instance of a bar 24, restaurant 22, or club 26, for example, may help the user 10 determine the atmosphere of the provider 20. Navigation icons 200 are provided to allow the user 10 to move forward and backward through the results. It is contemplated that various other configurations may be used to display the results without deviating from the scope of the invention.

Referring again to FIG. 4, the matching application 100 provides a review icon 122 to permit a user 10 to review a good or service which they have utilized or frequented. The review icon 122 launches a review screen that may be of similar form, for example, to the “create new product” screen 150 or to the “adjust sliders” screen 170. Optionally, various other configurations and arrangements of a user interface may be provided on the display 36 to solicit the review from the user 10. The user 10 identifies the good or service which they would like to review via the touch screen 37 and the mobile device 30 transmits the information identifying the good or service to the server 50. The server 50 retrieves the list of characteristics corresponding to the good or service to be reviewed from the storage device 56 and transmits the list back to the mobile device 30. The review screen displays each of the characteristics and the acceptable range of values for the characteristic. The user 10 enters the value for each characteristic that they feel best represents the good or service being reviewed via the touch screen 37 and these values are transmitted back the server 50. The server 50 aggregates the user's review with reviews from other users 10 and the average value of all of the users' reviews provide the subjective component of the values stored for each characteristic of a product.

By providing a subjective component to the values describing a product, the matching application 100 allows a portion of the value for each characteristic that may be influenced by the users 10. However, by providing a greater weight to the objective component (i.e., the portion of the value entered by an expert, a provider 20 of the product, or a combination thereof), the matching application 100 provides more consistent results. The expert and the provider each are motivated to provide an accurate description of the product. For example, the reputation of the expert may be influenced according to the accuracy of the review and the provider 20 will have increased sales if users seeking a particular product are drawn to their location. In contrast, users' reviews are often influenced by emotion, for example, based on one experience that may be skewed either very good or very bad. By limiting the weight of the user review, the objective component provides the basis for the values describing each characteristic of a product, but the subjective component of the user review is allowed to temper the objective component if a majority of users feel the product should be described in a different manner.

Saved searches may be particularly helpful to a user 10 searching for a good or service in an unfamiliar location. As previously indicated, a user 10 may save a search for a good or product either locally on the mobile device 30 or on the storage device 56 of the server 50. If a user 10 is satisfied with a good or service that was identified, for example, in the user's neighborhood or home city, the user 10 can retrieve the saved search when the user 10 is in an unfamiliar neighborhood or an entirely different city. Because the values of goods or services stored in the storage device 56 have an emphasis on objective elements, the matching application 100 will have a greater chance of identifying goods or services that match the user's expectations when the user 10 uses the same search criteria in different locations. It is further contemplated that a user 10 may choose to share a saved search with other users 10. For example, a user 10 in a first city may save a search that locates a popular restaurant in that first city. A user in another city may seek a similar dining experience and use the saved search to locate restaurants in the second city that are similar to the restaurants in the first city.

Turning next to FIG. 10, the matching application 100 may allow a user 10 to check in to a provider 20 which has the desired good or service. If, for example, the user 10 was searching for a particular style of beer, entered values for each of the characteristics of a beer, as discussed above, and a list of providers proximate to the user 10 was presented on the user's mobile device 30, the user 10 selects one of the providers 20, such as a bar 24, to visit. The matching application 100 is continuously retrieving the current location of the mobile device 30 from the positioning module 35. As a result, the matching application 100 can determine when the user 10 has arrived at the bar 24. The matching application 100 provides an interface to allow the user to check-in to the bar 24, indicating to the provider 20 that the user 10 has arrived. Rather than providing a list of the most relevant matches for the desired beer, the matching application 100 retrieves a list of products 72 being offered by the bar 24. It is contemplated that the provider 20 may either periodically provide a list of offered products 72 to the server 50 which in turn communicates the list to the mobile device 30. Optionally, the mobile device 30 may interface directly with a computer 80 of the provider 20 to obtain the list of products 72 offered.

The list of products 72 offered by the provider 20 is shown on a “product inventory” screen 210 on the display 36. The list identifies the name 212 of each product 72 as well as a percentage match 214 to the desired product. The user 10 is then made aware of all of the products 72 offered by the provider 20 and how well they correspond to the desired product. The user 10 may also initiate a new search when checked in to the provider and the percentage match 214 of each of the products 72 will be updated to correspond to how well the products 72 match the new search criteria. Optionally, the user 10 may select a name 212 of one the products 72 and an interface may be provided to the user 10 which shows the values corresponding to each characteristic for that specific product 72. Thus, the user 10 may be provided detailed information on the characteristics of a product 72 to make a better informed decision on which product 72 to select.

The provider 20 may also access saved searches to notify users 10 of sales or promotions offered by the provider 20. The provider 20 may, for example, have daily, weekly, or monthly specials. The provider 20 identifies the good or service on which the special applies. If the good or service has been previously stored on the server 50, the values of each characteristic may be loaded from the server 50. If the good or service is a new product 72 to be entered into the server 50, the provider 20 identifies the type of product and enters values for each of the characteristics which describe that type of product. The provider 20 may then transmit the identified good or service on which the promotion applies to the server 50. The server 50 compares the promotional product to saved searches and identifies those searches that most closely match the promotional product. The server 50 also retrieves data identifying the user 10 that conducted the search and transmits the details of the promotion to those users 10.

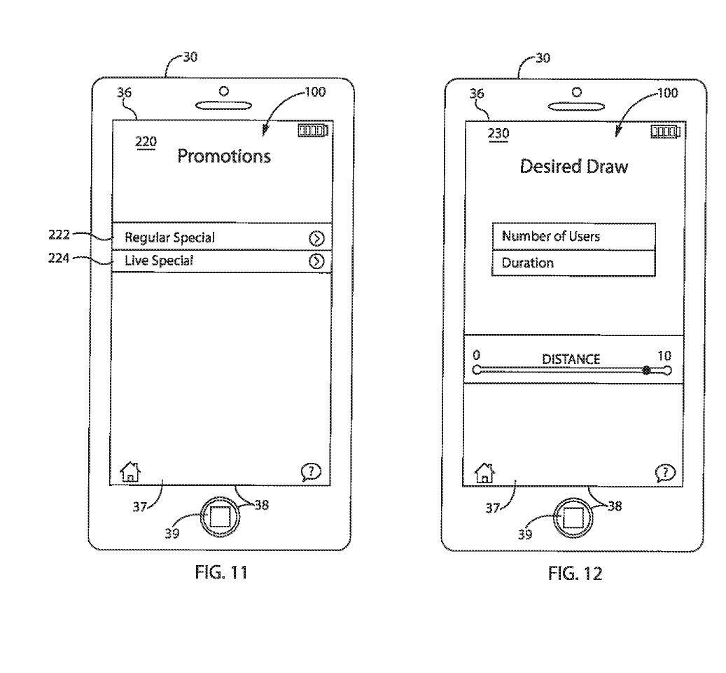

The provider 20 may enter the promotion from a promotion icon or menu item on the matching application 100. Although not shown, it is contemplated that different versions of the matching application 100 may be provided to a user 10 and a provider 20 or, optionally, different features of the matching application 100 may be activated if the login information corresponds to a user 10 or a provider 20. The promotion icon may take the provider 20 to a promotion screen 220, see FIG. 11, on which the provider 20 may enter the promotions offered by the provider. According to the illustrated embodiment, the promotion screen 220 allows the provider 20 to enter regular specials 222 or live specials 224. A regular special 222 may be, for example, a daily or weekly special and may be recurring and/or planned in advance. A live special 224 may be, for example, an impromptu promotion designed to bring in additional users 10.

When entering the details of the special, the provider 20 may also select a desired distribution method. The provider 20 may, for example, select a broadcast distribution where the details of the promotion are sent to all users 10 who searched for a similar good and service and returned where the user search matched the promotional product 72 at, for example, 75% or greater. According to another option, the provider 20 may broadcast the promotion to all users 10 within a certain range of the provider 20. If a user 10 has the matching application 100 executing in the background on the mobile device 30, the matching application 100 will continue to periodically transmit the present location of the user 10 to the server 50. Thus, the provider 20 may retrieve a list of users 10 within the defined region and notify them of the promotion. The provider 20 may do a combination of the first two options, for example, sending the promotion only to those users 10 in the area that conducted a search for the promotional product 72.

It is further contemplated that the provider 20 may select a desired draw distribution method. Although more applicable to a live special 224, the desired draw may also be used with a regular special 222. With a desired draw distribution, the provider 20 enters either a desired number of users 10 to draw to the provider 20 or a desired number of users 10 to receive the promotion. The purpose is to increase the number of customers at the provider 20. A desired draw screen 230 is provided to allow the provider 20 to enter the number of users 10 that the provider 20 would like to receive the live special 224. Optionally, the details of the desired draw screen 230 may be incorporated on a screen defining a regular or live special. The number of users 10 that the provider would like to draw may be defined as a numeric value or defined by all users within a certain range of the provider 20. A desired duration of the draw is also provided. Once the provider 20 has entered the parameters of the desired draw, the parameters are transmitted to the server 50.

The server 50 generates a ranking of users 10 to which the promotion is transmitted. The server 50 identifies users 10 who have previously checked in to the provider 20 (i.e., prior customers of the provider). The server 50 also retrieves all saved searches that match the promotional product 72 with a certain percentage to identify users 10 that may be interested in the promotion. The server 50 may store additional data about the user 10 such as how many times the user 10 has previously responded to a desired draw or frequency at which the user 10 searches for the promotional product. The server 50 then ranks the users 10 based on one or more of these criteria to provide a list of users 10 most likely to respond to the promotion. The server 50 retrieves the present location of each of the users 10 and filters the results based on the proximity of the user 10 to the provider. The server 50 then sends the details of the promotion to the mobile device 30 of the users 10 most likely to respond to the promotion that are also closest to the provider 20.

If a user 10 responds to a desired draw, the user 10 most check in with the provider 20 in order to receive the promotional offer. The server 50 monitors the number of users 10 checking in to the provider 20. If the number of users 10 that have checked into the provider 20 is not equal to the desired number of users within the duration provided, the server 50 may send out a second notice of the promotion. The server again filters the prior list of ranked users 10 within a broader radius from the provider 20. If some users 10 in the list have moved within range of the provider 20 they will receive the new notification. Similarly, those users 10 that were within the second radius from the provider 20 but not within the first radius from the provider 20 will also receive the new notification. The sequence may be repeated multiple times with an expanding radius in order to achieve a desired number of users 10 responding to the promotion as set up in the desired draw.

The above described invention will now be discussed with respect to a specific example. The following example is illustrative and is not intended to be limiting on the scope of the invention.

According to an exemplary embodiment, one type of product 72 for which a user 10 may search is beer. With reference also to FIG. 8, the list of characteristics for beer may include whether the beer is light or dark, sweet or bitter, crisp or creamy, the amount of hops in the beer, and the amount of malt in the beer. Initially, an expert on beers may be consulted to generate an objective value for each characteristic of a specific beer. A chocolate stout, for example, may be dark, sweet, creamy, have less hops and more malt. While all chocolate stouts may be similar in composition, the exact value of each characteristic along the scale will vary somewhat between breweries. The expert assigns values, either along a sliding scale, on a numeric scale, or a combination thereof, for each new beer added to the database. Each value from the expert becomes the objective component and is stored on the storage device 56 of the server 50. Alternately, a restaurant owner, chef, bartender or other individual with knowledge of the beer from a provider of the beer may assign a value for the objective component of each characteristic of a new beer. Each new beer is added to the database and stored on the storage device 56 of the server 50. It is further contemplated, that an expert and a provider may each assign a value for each characteristic of a beer and an averaged value or weighted average value of the two assigned values may be stored as the objective component. By providing such an objective component, a user who is searching for a particular beer, such as a chocolate stout, is more likely to identify beers that are either chocolate stouts or more nearly match a chocolate stout, such as a regular stout or an oatmeal stout rather than identifying, for example, a pilsner.

A user 10 is interested in finding a location that serves a particular beer, such as the aforementioned chocolate stout. The user 10 launches the matching application 100 on their mobile device 30 and logs in according to one of the methods illustrated in FIG. 3. By providing login information according to one of the options presented on the login screen 102, an identifier, such as a user name, is initially stored in the memory 34 of the mobile device 30 for later transmission with a search. The user 10 selects the product icon 116 from the home screen 114 using the touch screen 37 of the mobile device 30 to begin a search for a desired beer. If the user 10 has previously searched for their favorite chocolate stout, they may select the “favorite product” option bar 134 via the touch screen 37, which will show the “favorite product” screen 160 on the display 36. The user 10 may enter the name of their favorite chocolate stout. The mobile device 30 will retrieve the saved search either from the memory 34 of the mobile device 30 or from the storage device 56 on the server 50, depending on where saved searches are stored.

If this is the first time a user 10 is searching for the particular chocolate stout, the user may select the “adjust sliders” option bar 136 via the touch screen 37 and the “adjust sliders” screen 170 will be shown on the display 36. Either on an intermediate screen or on the “adjust sliders” screen 170, the user 10 enters the product description 172 (e.g., beer) for which the user 10 is searching. The mobile device 30 then receives the list of characteristics corresponding to beer for display on the touch screen 37. It is contemplated that the lists of characteristics for various products either may be provided with the matching application 100 and stored in memory 34 on the mobile device 30 or may be stored in the storage device 56 in communication with the server 50. The matching application 100 retrieves the list of characteristics for “beer” either from the memory 34 of the mobile device 30 or transmits the description of the desired product (i.e., beer) to the server 50 and the server 50 retrieves the list from the storage device 56 and transmits it back to the mobile device 30. The various slider bar objects 174 are then populated according to the list of characteristics for beer and the corresponding ranges for each characteristic. The user 10 moves the sliders 178 along each slider bar 176 via the touch screen 37 according to his or her opinion on where each characteristic of the desired product is positioned. The user selects the submit icon 180 to transmit the values of each characteristic from the mobile device 30 to the server 50. Along with the values, the identifier, stored at login, is also transmitted from the mobile device 30 to the server 50. The server 50 may then store the values and the identifier as a search in the storage device 56 to be retrieved for future use. It is further contemplated that a manufacturer and/or product name of chocolate stouts from various manufacturers may be entered by the expert and/or provider and saved in the storage device 56. Thus, a user 10 may enter a desired product name on the “favorites” screen 160 or select a specific manufacturer and/or product in the list of saved searches to conduct a search for a specific beer.

The server 50 compares each of the values for the characteristics of the chocolate stout against the lists of characteristics for each beer stored in the storage device 56. The server 56 determines how close each of the lists stored in the storage device 56 match the values for the chocolate stout and generates a ranking of the lists according to how close they match the values of the chocolate stout. The server 50 then filters the rankings based on the location data from the mobile device 30. The user 10 may have set a limit for the search to, for example, a ¼ mile radius. Thus, a perfect match located ½ mile from the mobile device 30 may not be included in the results list while a near match within the ¼ mile radius is included in the results list. The server 50 transmits the results list to the mobile device 30 and the mobile device 30 shows the results in the “product match” screen 190 on the display 36.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method of identifying one of a desired good and a desired service, the method comprising the steps of:
receiving a list of characteristics corresponding to the desired good or service with a mobile device, wherein the list of characteristics includes a range of values for each characteristic;
entering a value for at least one characteristic for the desired good or service using a user interface on the mobile device, wherein each value is selected from within the range of values for the at least one characteristic;
transmitting the value for each characteristic entered from the mobile device to a server via a network interface in the mobile device;
transmitting location data generated in a positioning module on the mobile device to the server via the network interface;
receiving a results list of goods or services with the mobile device from the server via the network interface, wherein the results list is generated in the server by:
comparing the value for each characteristic to a corresponding value in a plurality of lists of characteristics stored in a storage device in communication with the server, each list corresponds to one of a plurality of goods or services, each of the plurality of lists includes a predefined rating within the range of values for each of the characteristics in the list, the predefined rating includes an objective component and a subjective component, the objective component is greater than the subjective component,
ranking each of the plurality of goods or services stored in the storage device according to the comparison between the value for each characteristic and the predefined rating for the corresponding characteristic, and
filtering each of the ranked plurality of goods or services according to the location data; and
displaying the results list on a display of the mobile device.

2. The method of claim 1, further comprising the steps of:
entering a description of the desired good or service using the user interface on a mobile device; and
transmitting the description of the desired good or service to the server via the network interface, wherein the list of characteristics corresponding to the desired good or service are received with the mobile device from the server via the network.

3. The method of claim 1, wherein the list of characteristics corresponding to the desired good or service are received with the mobile device from a memory of the mobile device.

4. The method of claim 1, wherein the objective component of the predefined rating includes a value assigned by a provider of the good or service.

5. The method of claim 1, wherein the objective component of the predefined rating includes a value assigned by an independent third party.

6. The method of claim 1, wherein the subjective component of the predefined rating includes an average value from a plurality of values, each of the plurality of values assigned by a user.

7. The method of claim 1, wherein the step of transmitting location data generated in the positioning module on the mobile device to the server via the network interface is repeated at a periodic interval, and wherein a new results list is received with the mobile device from the server responsive to the transmission of each location data.

8. The method of claim 1, further comprising the steps of:
identifying a provider of each of the goods or services in the results list transmitted to the mobile device;
checking in to one of the providers with the mobile device; and
obtaining a second results list on the mobile device of the plurality of goods or services that are offered by the provider.

9. A method of matching at least one user of a good or a service with at least one provider of the good or the service, the method comprising the steps of:
storing a plurality of lists of characteristics in a storage device in communication with a server, wherein each of the lists includes an assigned value for each characteristic defining the good or service from the at least one provider, and wherein the assigned value includes an objective component and a subjective component, and wherein the objective component is greater than the subjective component;
one of a user and a provider entering a description of the good or service via a user interface on a remote processing device;
transmitting the description of the good or service from the remote processing device to the server via a network interface in the remote processing device;
transmitting location data generated in a positioning module on the remote processing device of the user to the server via the network interface;
when the user entered the description of the good or service, identifying at least one provider of the good or service, and
when the provider entered the description of the good or service, identifying at least one user of the good or service, wherein the at least one provider or the at least one user is identified as a function of the assigned values for each characteristic of the desired good or service and further identified as a function of the location data from the user.

10. The method of claim 9, wherein the user entered the description of the desired good or service and the remote processing device is a mobile device, the method further comprising the steps of:
receiving a list of the plurality of characteristics on the mobile device corresponding to the description of the good or service,
entering a desired value for at least one of the plurality of characteristics using the user interface on the mobile device; and
transmitting the desired value for each of the plurality of characteristics from the mobile device to the server via the network interface.

11. The method of claim 10, further comprising the steps of:
transmitting an identifier from the mobile device to the server via the network interface; and
storing the desired value entered for each of the plurality of characteristics and the identifier in the storage device as a search.

12. The method of claim 10, wherein:
the location data is transmitted to the server from the mobile device via the network interface at a periodic interval; and
the at least one provider is identified at the periodic interval.

13. The method of claim 10, wherein the objective component of the assigned value for each of the plurality of characteristics is assigned by at least one of a provider of the good or service and an independent third party.

14. The method of claim 13, wherein the subjective component of the assigned value for each of the plurality of characteristics is assigned by a plurality of users.

15. The method of claim 9, wherein the provider entered the description of the desired good, further comprising the steps of:
entering a promotion via the user interface on the remote processing device, wherein the promotion is related to the desired good or service;
entering a notification criterion via the user interface on the remote processing device;
transmitting the promotion and the notification criterion to the server via the network interface, wherein the at least one user of the good or service is identified also as a function of the notification criterion; and
transmitting the promotion from the server to the mobile device of each of the users identified.

16. The method of claim 15, wherein the notification criterion is a desired number of users and wherein the server identifies each of the desired number of users which are closest to the provider as a function of the location data of the user, the method further comprising the step of logging each of the users responding to the promotion at the server.

17. The method of claim 16, further comprising the steps of:
storing the number of users responding to the promotion for a predefined time in the storage unit; and
when the number of users responding to the promotion is less than the desired number of users after the predefined time, identifying additional users corresponding to a difference between the desired number of users and the number of users responding to the promotion of the good or service, wherein the additional users are the next closest users to the provider that satisfy the notification criterion.

18. The method of claim 15, further comprising the steps of retrieving a list of the plurality of characteristics defined for the good or service from the storage device;
the provider entering the value for at least one of the plurality of characteristics on the remote processing device via the user interface;
transmitting the value entered for each of the plurality of characteristics to the server via the network interface;
comparing the value entered for each of the plurality of characteristics to a plurality of searches stored in the storage device;
retrieving from the storage device a user associated with each of the plurality of searches that correspond to the value entered for each of the plurality of characteristics, wherein the user of the good or service is identified also as a function of a ranking of each user associated with each of the plurality of searches.

19. A mobile device configured to identify one of a desired good and a desired service, the mobile device comprising:
a positioning module configured to generate location data of the mobile device;
a network interface configured to wirelessly communicate with at least one other device;
a user interface configured to receive input from a user of the mobile device;
a memory configured to store a plurality of instructions;
a processor configured to execute the instructions to:
receive a list of characteristics corresponding to the desired good or service with the mobile device, wherein the list of characteristics includes a range of values for each characteristic;
receive a value for at least one characteristic for the desired good or service entered on the user interface, wherein each value is selected from within the range of values for the at least one characteristic;
transmit the values for each characteristic entered via the network interface to a server in communication with the network interface;
transmit the location data to the server via the network interface; and
receive a results list of goods or services with the mobile device from the server via the network interface, wherein the results list is generated in the server by:
comparing the values for each characteristic to a corresponding value in a plurality of lists of characteristics stored in a storage device in communication with the server, each list corresponds to one of a plurality of goods or services, each of the plurality of lists includes a predefined rating within the range of values for each of the characteristics in the list, the predefined rating includes an objective component and a subjective component, the objective component is greater than the subjective component,
ranking each of the plurality of goods or services stored in the storage device according to the comparison between the values for each characteristic and the predefined rating for the corresponding characteristic, and
filtering each of the ranked plurality of goods or services according to the location data; and
a display configured to present the results list to the user of the mobile device.
